(19) United States
(12) Patent Application Publication
(10) Pub. No.: US 2019/0188507 A1
(43) Pub. Date: Jun. 20, 2019

(54) Altering Biometric Data Found in Visual Media Data

(71) Applicant: Lenovo (Singapore) Pte. Ltd., Singapore (SG)

(72) Inventors: Robert J. Kapinos, Durham, NC (US); Timothy W. Kingsbury, Cary, NC (US); Scott W. Li, Cary, NC (US); Russell S. VanBlon, Raleigh, NC (US)

(21) Appl. No.: 15/842,487

(22) Filed: Dec. 14, 2017

(51) Int. Cl. G06K 9/00

(52) U.S. Cl. CPC G06K 9/00885; G06K 9/00067; G06K 2009/00953; G06K 9/0061; G06K 2009/00966; G06K 9/00268

(57) ABSTRACT

An approach is disclosed that receives a set of visual media data that corresponds to a person. The process detects that a portion of the visual media data is biometric data that corresponds to the person. Responsively, the process alters the biometric data so that the altered biometric data fails to identify the person.

### BACKGROUND

With the growth of high resolution cameras and high definition media, individuals are subject to identity theft by malevolent people who can use published content to manufacture false biometric signatures. Arbitrary people can copy fingerprints, iris data, and login actions from published web media available to the public. Both individuals who appear in media and media publishers may be liable for losses due to identity theft through publication of high resolution images.

### SUMMARY

An approach is disclosed that receives a set of visual media data that corresponds to a person. The process detects that a portion of the visual media data is biometric data that corresponds to the person. Responsively, the process alters the biometric data so that the altered biometric data fails to identify the person.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a high level diagram depicting steps taken to provide biometric protection for publication of high resolution images;

FIG. 4 is a flowchart depicting steps taken to alter biometric content found in media;

FIG. 5 is a diagram steps taken during publication of content while providing biometric protection; and

FIGS. 6A and 6B show examples of providing biometric protection by altering content that otherwise divulges a person's biometric information.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

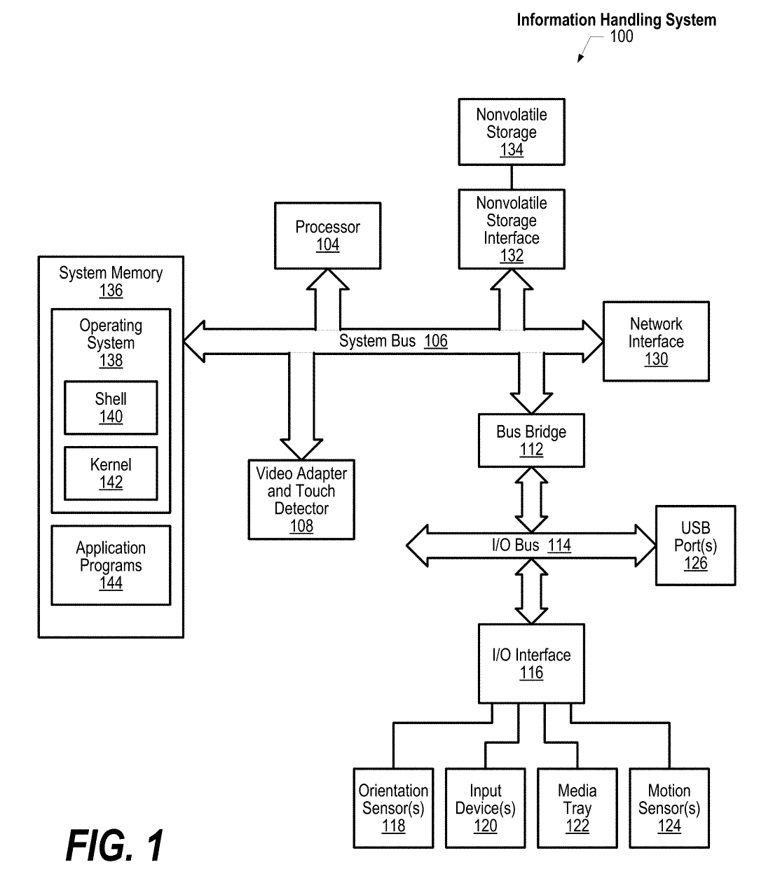

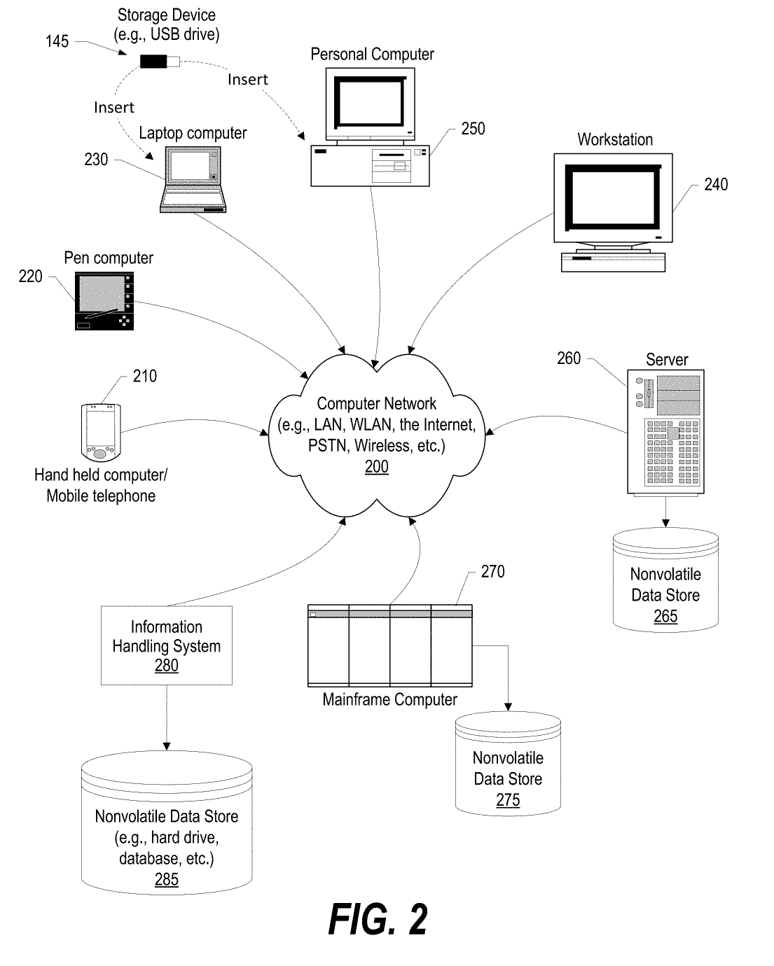

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Note that some or all of the exemplary architecture, including both depicted hardware and software, shown for and within information handling system 100 may be utilized by a software deploying server, such as one of the servers shown in FIG. 2.

Information handling system 100 includes processor 104 that is coupled to system bus 106. Processor 104 may utilize one or more processors, each of which has one or more processor cores. Video adapter 108, which drives/supports touch screen display 110, is also coupled to system bus 106. System bus 106 is coupled via bus bridge 112 to input/output (I/O) bus 114. I/O interface 116 is coupled to I/O bus 114. I/O interface 116 affords communication with various I/O devices, including orientation sensor 118, input device(s) 120, media tray 122 (which may include additional storage devices such as CD-ROM drives, multi-media interfaces, etc.), motion sensor 124, and external USB port(s) 126. Input devices 120 include keyboard layer 310 that, in one embodiment, provides a platform for the information handling system when the information handling system is configured in a laptop configuration. Also, in one embodiment, keyboard layer 310 is a hinged component that can be rotated, or moved, respective to touch layer 320 and display screen layer 330. In one embodiment, touch layer 320 is a rigid layer, while in an alternate embodiment, touch layer 320 is flexible. In one embodiment, touch layer 320 is coupled to at least one of the other components (touch screen display 110 or keyboard component 310) with a hinge, while in another embodiment the touch layer is coupled to at least one of the other components with another type of attachment mechanism.

Touch screen display 110 includes touch layer 320 which is a touch-sensitive grid that can be rotated by a hinge to overlay either keyboard layer 310 or display screen layer 330. Touch screen display 110 allows a user to enter inputs by directly touching touch screen display 110. In one embodiment, keyboard layer 310, touch layer 320, and display screen layer 330 are each attached via sets of hinges that allows each of these layers to be rotated, or moved, respective to the other layers.

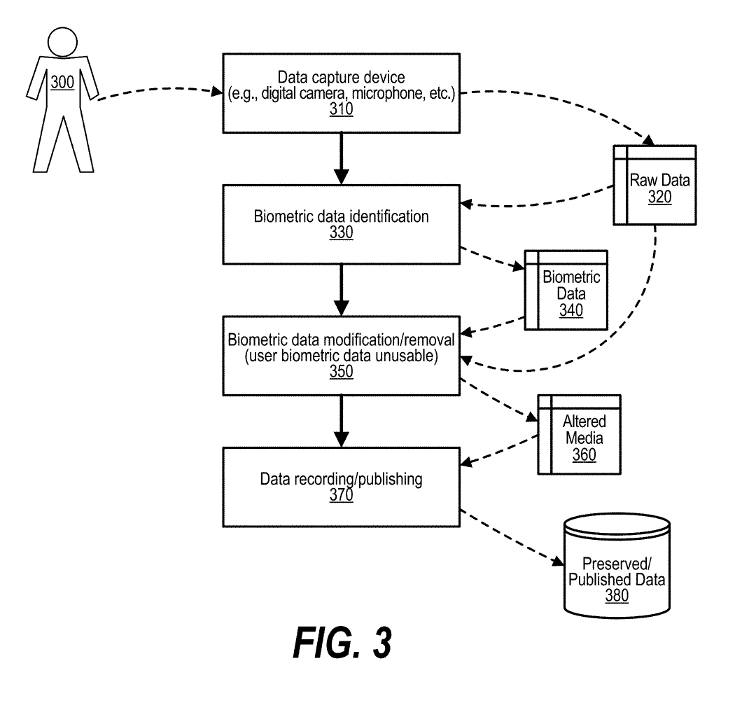

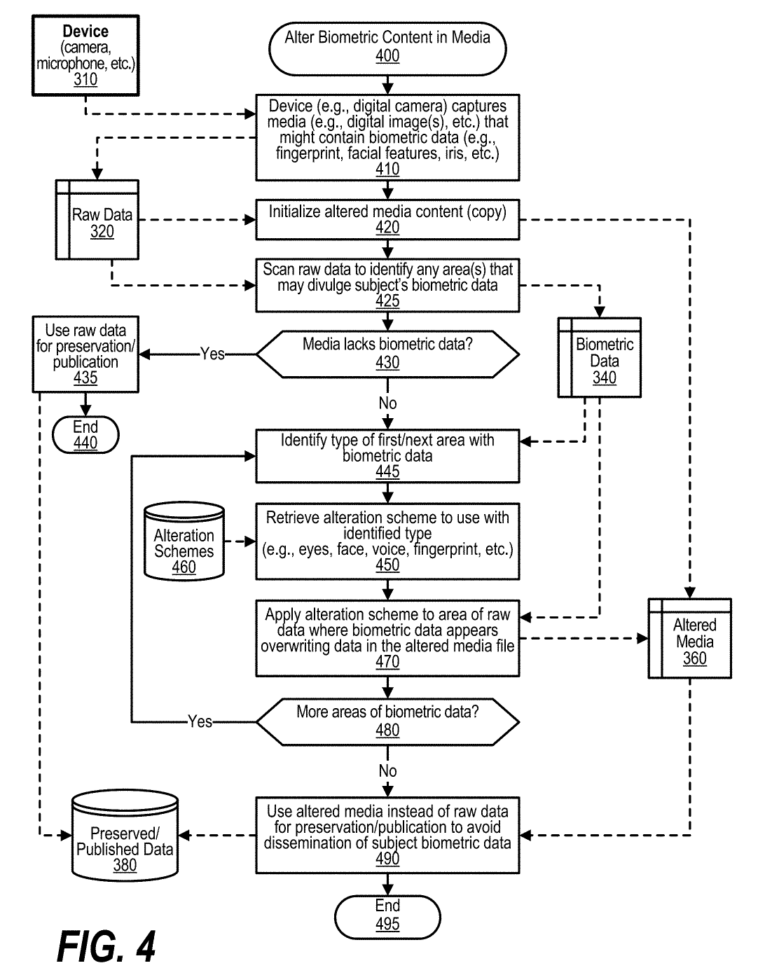

Orientation sensor(s) 118 are one or more sensors and/or associated logic that senses the physical/spatial orientation of information handling system 100. For example, a simple gravity detector can tell if the information handling system is being held right-side-up, upside down, parallel to or perpendicular to the ground (e.g., a walking surface), at some other angle relative to the ground, etc. In another example, orientation sensor 118 is a set of accelerometers, strain gauges, etc. that provide real-time information describing the physical orientation of information handling system 100 in three-dimensional space, including such orientation with respect to the earth/ground/floor. In addition, one or more orientation sensors 118 are used to depict the current configuration of the information handling system with a hinge connecting keyboard layer 310, touch layer 320, and display screen layer 330. These orientations provide orientation data pertaining to the various layers to ascertain, for example, if touch layer 320 is overlaying keyboard layer 310 or display screen layer 330. One or more of these orientation sensors determine if the display screen layer is positioned in a “portrait” mode or a “landscape” mode. Furthermore, data from orientation sensors 118 is used to determine if the information handling system is positioned in a traditional laptop mode (see examples, FIG. 3), a closed or “transport” mode (see example, FIG. 4), a standing or “yoga” mode (see example, FIG. 4), or some other physical configuration.

Motion sensor(s) 124 include one or more sensors and/or associated logic that senses the direction, speed, and/or acceleration of movement of information handling system 100 and components such as the keyboard layer, touch layer, and display screen layer. For example, a combination of accelerometers, strain gauges, etc. (described above with respect to orientation sensor 118) can also be used to detect how fast and in what direction information handling system 100 or the individual components is moving, as well as the acceleration of movement of information handling system 100 or the individual components. For example, motion sensor 124, either alone or in combination with the orientation sensor 118 described above, is able to detect if information handling system 100 is being handed from one person to another based on the rate of acceleration during the hand-off (e.g., faster than normal walking acceleration), the yaw orientation of information handling system 100 during the hand-off (e.g., a rotating movement indicating that the computer is being turned around for another person to see during a hand-off of the computer from one person to another), the pitch orientation of information handling system 100 during the hand-off (e.g., the front of information handling system 100 being tilted upwards during the hand-off of the computer from one person to another), and/or the roll orientation of information handling system 100 during the hand-off (e.g., a side of the computer rolling upwards during the hand-off of the computer of the computer from one person to another). In one embodiment, motion sensor 124 (alone or in combination with orientation sensor 118) is able to detect an oscillating motion of information handling system 100, such as that motion created with a user is walking and holding a tablet computer in her hand (and at her side) while swinging her arms forward and backward. In addition, motion sensors 124 is able to detect the movement of one or more of the layers included in the information handling system (keyboard layer 310, touch layer 320, and display screen layer 330). For example, motion sensors 124 can detect if the user is moving the touch layer in a direction to overlay the keyboard layer or the display screen layer. Likewise, motion sensors can detect that the user is moving the layers to position the information handling system in a traditional laptop orientation, a tablet orientation, a clamshell or “transport” orientation, or any other orientation possible with the information handling system. Information handling system 100 may be a tablet computer, a laptop computer, a smart phone, or any other computing device that has a keyboard layer, a touch layer, and a display screen layer.

Nonvolatile storage interface 132 is also coupled to system bus 106. Nonvolatile storage interface 132 interfaces with one or more nonvolatile storage devices 134. In one embodiment, nonvolatile storage device 134 populates system memory 136, which is also coupled to system bus 106. System memory includes a low level of volatile memory. This volatile memory also includes additional higher levels of volatile memory, including cache memory, registers and buffers. Data that populates system memory 136 includes information handling system 100's operating system (OS) 138 and application programs 144. OS 138 includes a shell 140, for providing transparent user access to resources such as application programs 144. As depicted, OS 138 also includes kernel 142, which includes lower levels of functionality for OS 138, including providing essential services required by other parts of OS 138 and application programs 144, including memory management, process and task management, disk management, and mouse and keyboard management.

The hardware elements depicted in information handling system 100 are not intended to be exhaustive, but rather are representative to highlight essential components required by the present invention. For instance, information handling system 100 may include alternate memory storage devices such as magnetic cassettes, digital versatile disks (DVDs), Bernoulli cartridges, and the like. These and other variations are intended to be within the spirit and scope of the present invention.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

FIG. 3 is a high level diagram depicting steps taken to provide biometric protection for publication of high resolution images. Digital capture device 310, captures visual media data, such as a digital video or a digital photograph, which is taken of a person shown here as user 300. The visual media data might include biometric data that can be used to identify user 300. In some systems, “spoofing” such biometric data might allow a malevolent user to pose as user 300 to access various resources, such as online accounts that are protected using such biometric data. Data capture device 310 captures the visual media data and stores the raw data in memory area 320. The raw data includes any biometric data corresponding to user 300 that was included in the video or photo that was captured.

At step 330, a process detects that a portion of the visual media data stored in memory area 320 is biometric data that corresponds to the user. The biometric data that is detected is stored in memory area 340.

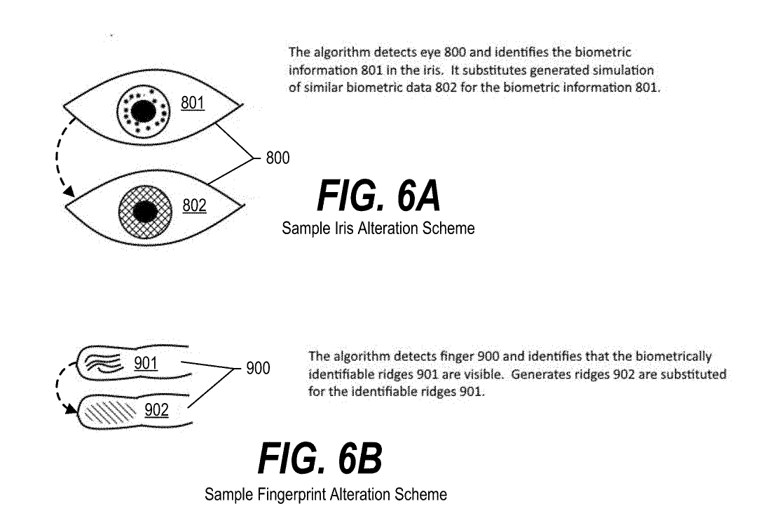

At step 350, a process alters the biometric data so that the altered biometric data cannot be used to uniquely identify the person (user 300) from which the biometric data was captured. FIG. 6 shows some examples of altering biometric data areas, such as images of the user's eyes, so that the altered set of visual media data cannot be used to uniquely identify the user. This altered set of visual media data is stored in memory area 360.

At step 370, a process performs a data recording or publishing function which uses the altered set of visual media data instead of the raw data when publishing or recording the user's image that was taken by the digital capture device. The preserved or published visual media data of the person whose image was captured is thereby an altered image that does not include the person's biometric data that could be used to uniquely identify the person whose image was taken. This preserved/published visual media data is stored in data store 380.

FIG. 4 is a flowchart depicting steps taken to alter biometric content found in media. FIG. 4 processing commences at 400 and shows the steps taken by a process that alters biometric content data in visual media data. At step 410, the process captures visual media data, such as digital image, videos, etc. using digital capture devices, such as digital camera 310. The visual media data that is captured might contain biometric data, such as fingerprints, facial features, eye (iris), etc. The raw visual image data is stored in memory area 320. At step 420, the process initializes altered media content that is stored in memory area 360 by making a copy of the visual image data stored in memory area 320. At step 425, the process scans the raw visual image data to identify any portions of the visual media data that may contain biometric data that might divulge the subject's biometric data, such as a fingerprint. The portions that might contain biometric data are stored in memory area 340.

The process determines whether the visual media data lacks any biometric data, such as an image that does not include a person or an image of a person that does not divulge any of the person's biometric data (decision 430). If the visual media data lacks any biometric data, then decision 430 branches to the ‘yes’ branch whereupon, at step 435, the process uses the raw (unaltered) visual media data for preservation and/or publishing since the visual media data does not divulge any biometric data and processing thereafter ends at 440. On the other hand, if the visual media data includes any biometric data, then decision 430 branches to the ‘no’ branch for further processing of the biometric data areas.

At step 445, the process identifies the type of the first portion of the visual media data that includes biometric data. Types of biometric data might include fingerprints, eyes, facial features, and the like. At step 450, the process retrieves the alteration scheme that is used to alter the identified type of biometric data. For example, the alteration scheme used to alter a fingerprint might be wavy lines that are not the person's fingerprint. Likewise, the alteration scheme used to alter eyes might be eye coloration and features that appear like a human eye but are not the person's eye details. These alteration schemes are retrieved from data store 460. See FIG. 6 for example alteration schemes applied to example biometric data areas. At step 470, the process applies the selected alteration scheme to the area of raw data where the biometric data appears, thereby overwriting the original data in the altered media file. For example, overlaying the altered fingerprints for the person's actual fingerprints in the altered media file that is stored in memory area 360.

The process determines as to whether there are more portions of biometric data that were detected in the visual media data (decision 480). If there are more portions of biometric data that were detected in the visual media data, then decision 480 branches to the ‘yes’ branch which loops back to step 445 to select and alter the next portion containing biometric data as described above. This looping continues until there are no more portions of biometric data to process, at which point decision 480 branches to the ‘no’ branch exiting the loop.

At step 490, the process uses the altered set of visual media data stored in memory area 360 instead of the raw visual media data for preservation and publication of the visual media data in order to avoid dissemination of the person's actual biometric data. FIG. 4 processing thereafter ends at 495.

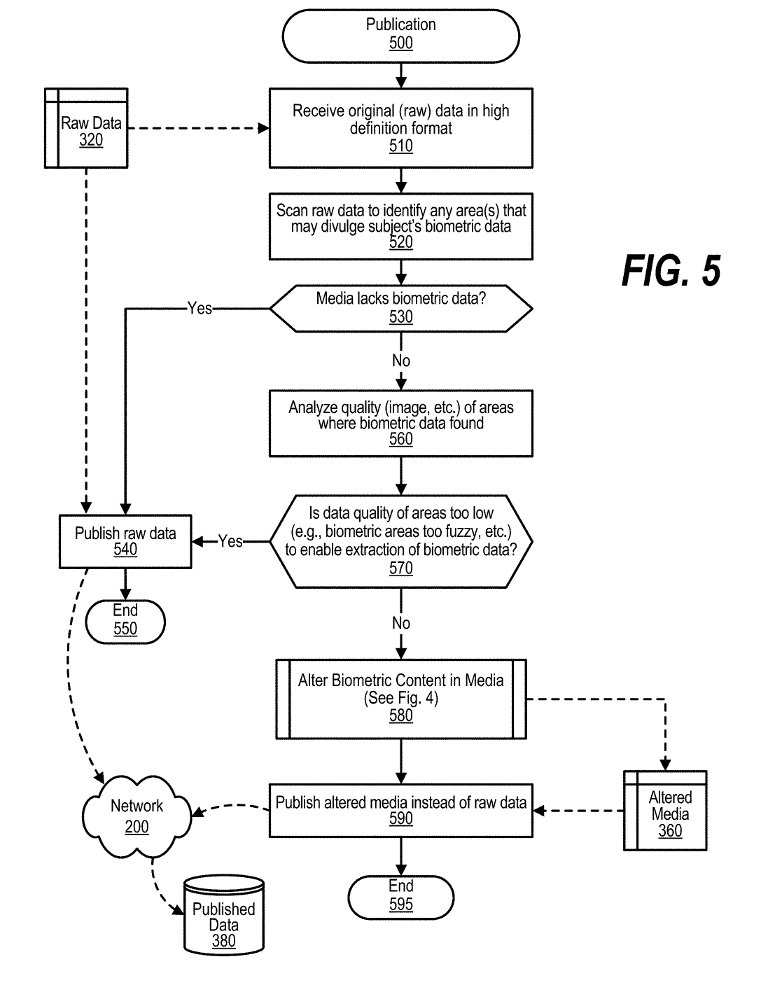

FIG. 5 is a diagram steps taken during publication of content while providing biometric protection. FIG. 5 processing commences at 500 and shows the steps taken by a process that publishes visual media data that might include images of a person with the steps altering the visual image data so that the person's biometric data is not divulged in the publication. The publication can be a print or online publication and can also be an automatic process that publishes digital images to an online social media site. At step 510, the process receives the original (raw) visual media data in high definition format with the raw data being received from memory area 320. For example, the raw data might be a visual image of a person that is being uploaded to a social media site.

At step 520, the process scans the visual media data included in the raw data to identify any portions of the visual media data that might divulge a person's biometric data. The process determines whether the visual media data lacks any biometric data of a person, such as a image that does not include a person or an image of a person taken in a manner that does not divulge the person's biometric data (decision 530). If the visual media data lacks any biometric data, then decision 530 branches to the ‘yes’ branch whereupon, at step 540, the process publishes the raw form of the visual media data without altering the data as the data does not divulge any biometric data of a person and processing thereafter ends at 550. On the other hand, if the visual media data includes any biometric data, then decision 530 branches to the ‘no’ branch for further processing. At step 560, the process analyzes the quality of the visual media data with particular analysis of any areas where biometric data might found.

The process determines whether the data quality of the biometric areas is too low to divulge biometric information, such as the images of the biometric areas being too fuzzy, at an angle that prevents extraction of a person's biometric data (decision 570). If the data quality of the biometric areas is too low to enable extraction of the biometric data, then decision 570 branches to the ‘yes’ branch to perform steps 540 and 550 as described above. On the other hand, if the data quality of the biometric areas is not too low to so that extraction of a person's biometric data might be possible, then decision 570 branches to the ‘no’ branch for further processing. At predefined process 580, the process performs the Alter Biometric Content in Media routine (see FIG. 4 and corresponding text for processing details). This routine alters the biometric data portions found in the visual media data and results in an altered set of visual media data that is stored in memory area 360.

At step 590, the process publishes the altered set of visual media data. In one embodiment, such as in a social media site, the publication writes the altered set of visual media data to data store 380 that is accessible from computer network 200, such as the Internet. FIG. 5 processing thereafter ends at 595.

FIGS. 6A and 6B show examples of providing biometric protection by altering content that otherwise divulges a person's biometric information. FIG. 6A depicts biometric data of eye 800 being altered so that the altered eye cannot be used to biometrically identify the person whose eye was captured in the visual media data. The detecting process detects eye 800 and that biometric information as shown in 801 has been collected in the visual media data. The approach alters the biometric data and generates eye iris 802 that cannot be used to biometrically identify the person that was photographed.

FIG. 6B depicts biometric data of fingerprint 900 being altered so that the altered fingerprint cannot be used to biometrically identify the person whose fingerprint was captured in the visual media data. The detecting process detects fingerprint 900 and that biometric information as shown in fingerprint 901 has been collected in the visual media data. The approach alters the biometric data and generates fingerprint 902 that cannot be used to biometrically identify the person that was photographed.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method comprising:
receiving a publication request at an online social media site, wherein the publication request includes a set of digital visual media data corresponding to a person;
automatically detecting that a portion of the digital visual media data that is biometric data that corresponds to the person;
automatically altering the biometric data so that the altered biometric data fails to identify the person, the altering resulting in an altered set of digital visual media data wherein the person is still recognizable in the altered set of digital visual media data; and
publishing the altered set of digital visual media data at the online social media site.

2. The method of claim 1 further comprising:
receiving the set of visual media data by capturing the visual media data at a digital device; and
storing the altered set of media in a storage area of the digital device.

3. The method of claim 1 wherein the portion of the visual media data is a digital image of the person's eye, and wherein the method further comprises:
modifying one or more features of the digital image so that eye details appear human yet inhibit identification of the person.

4. The method of claim 1 wherein the portion of the visual media data is a digital image of the person's fingertip, and wherein the method further comprises:
modifying one or more lines comprising a fingerprint found on the fingertip wherein the modified fingerprint appears natural yet inhibits identification of the person.

5. The method of claim 1 wherein the portion of the visual media data is a digital image of the person's face, and wherein the method further comprises:
modifying one or more facial features found in the digital image wherein the modified facial features appear similar to the person's facial features yet inhibit identification of the person.

6. (canceled)

7. (canceled)

8. An information handling system comprising:
one or more processors;
a memory accessible by at least one of the processors;
a set of instructions stored in the memory and executable by at least one of the processors to:
receive a publication request at an online social media site, wherein the publication request includes a set of digital visual media data corresponding to a person;
automatically detect that a portion of the digital visual media data that is biometric data that corresponds to the person;
automatically alter the biometric data so that the altered biometric data fails to identify the person, the alteration results in an altered set of digital visual media data wherein the person is still recognizable in the altered set of digital visual media data; and
publish the altered set of digital visual media data at the online social media site.

9. The information handling system of claim 8 further comprising:
a nonvolatile storage area accessible by at least one of the processors; and
a digital camera accessible by at least one of the processors, wherein the instructions are further executable by at least one of the processors to:
receive the set of visual media data by capturing the visual media data at the digital camera; and
store the altered set of media in the nonvolatile storage area.

10. The information handling system of claim 8 wherein the portion of the visual media data is a digital image of the person's eye, and further comprising instructions that are further executable by at least one of the processors to:
modify one or more features of the digital image so that eye details appear human yet inhibit identification of the person.

11. The information handling system of claim 8 wherein the portion of the visual media data is a digital image of the person's fingertip, and further comprising instructions that are further executable by at least one of the processors to:
modify one or more lines comprising a fingerprint found on the fingertip wherein the modified fingerprint appears natural yet inhibits identification of the person.

12. The information handling system of claim 8 wherein the portion of the visual media data is a digital image of the person's face, and further comprising instructions that are further executable by at least one of the processors to:
modify one or more facial features found in the digital image wherein the modified facial features appear similar to the person's facial features yet inhibit identification of the person.

13. (canceled)

14. (canceled)

15. A computer program product comprising:
a computer readable storage medium comprising a set of computer instructions, the computer instructions effective to:
receive a publication request at an online social media site, wherein the publication request includes a set of digital visual media data corresponding to a person;
automatically detect that a portion of the digital visual media data that is biometric data that corresponds to the person;
automatically alter the biometric data so that the altered biometric data fails to identify the person, the alteration results in an altered set of digital visual media data wherein the person is still recognizable in the altered set of digital visual media data; and
publish the altered set of digital visual media data at the online social media site.

16. The computer program product of claim 15 wherein the computer instructions are further effective to:
receive the set of visual media data by capturing the visual media data at a digital device; and
store the altered set of media in a nonvolatile storage area.

17. The computer program product of claim 15 wherein the portion of the visual media data is a digital image of the person's eye, and further comprising instructions that are further executable by at least one of the processors to:
modify one or more features of the digital image so that eye details appear human yet inhibit identification of the person.

18. The computer program product of claim 15 wherein the portion of the visual media data is a digital image of the person's fingertip, and further comprising instructions that are further executable by at least one of the processors to:
modify one or more lines comprising a fingerprint found on the fingertip wherein the modified fingerprint appears natural yet inhibits identification of the person.

19. (canceled)

20. (canceled)
